(19) United States
(12) Patent Application Publication
(10) Pub. No.: US 2022/0270103 A1
(43) Pub. Date: Aug. 25, 2022

(54) SYSTEM AND METHOD FOR A DATA PROTECTION MODE

(71) Applicant: Wells Fargo Bank, N.A., San Francisco, CA (US)

(72) Inventor: JOON MAENG, NEWCASTLE, WA (US)

(21) Appl. No.: 15/160,456

(22) Filed: May 20, 2016

(51) Int. Cl. G06Q 20/40; G06Q 20/36; G06Q 20/38

(52) U.S. Cl. CPC G06Q 20/40145; G06Q 20/3674; G06Q 20/3821

(57) ABSTRACT

A method may include storing, in a storage device of a mobile device, a mobile wallet element, the mobile wallet element including protected information and non-protected information; receiving a request, on the mobile device, to display the mobile wallet element in a protected mode; accessing preferences for displaying the mobile wallet element in the protected mode; and in response to the request: enabling a protected mode display of the mobile wallet element; displaying, on a display device of the mobile device, the non-protected information of the mobile wallet element according to the preferences; and restricting access to the protected information while the protected mode is enabled.

### TECHNICAL FIELD

Embodiments described herein generally relate to data access, and in particular, but without limitation to, a system and method for a data protection mode.

### BACKGROUND

Mobile wallets may be used for a variety of tasks including payments at a point-of-sale terminal, payments during an online web session, and payments using an application on a mobile device. A mobile wallet may store one or more wallet elements (e.g., credit cards, bank account identification, student identification) for payments or presentation of information. Information in the wallet elements may be presented to a requesting user for proof of identification, among other reasons.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram of components of a mobile device, according to various examples;

FIG. 2 is an element customization interface, according to various examples;

FIG. 3 is a flowchart of a method of presenting a mobile wallet element, according to various examples;

FIG. 4 is a flowchart of a method of using a protected mode for a mobile wallet element, according to various examples; and

FIG. 5 is a block diagram illustrating an example machine upon which any one or more of the techniques (e.g., methodologies) discussed herein may be performed, according to an example embodiment.

### DETAILED DESCRIPTION

A user may have a mobile wallet installed as an application on his or her mobile device. However, in other examples the mobile wallet may be hosted on a device external to the mobile device such as a server and the user may access the mobile wallet through a website.

A mobile wallet may be used for a variety of purposes. For example, the wallet may be used to make payments in a variety of ways including at a contactless terminal (e.g., point-of-sale (POS) card readers) and through native applications operating on a mobile device. To make a payment at a merchant's store a user may select a wallet element (e.g., credit card item) of the mobile wallet for the transaction and place the mobile device near the contactless terminal. The mobile device may then wirelessly transfer unique account information (e.g., token and cryptograph) for the credit card to the contactless terminal using near field communication (NFC) or magnetic secure transmission (MST), for example. Exemplary payment elements are credit cards, debit cards, coupons, gift cards, royalty points, subway pass, tickets, and other forms which may be used as payment or equivalent to payment

Mobile wallets are not limited to payment elements, however, and may include non-payment elements. Exemplary non-payment elements may include a driver's license, insurance card, student ID, passport, employee card, social security card, and other forms that are not associated with monetary transactions.

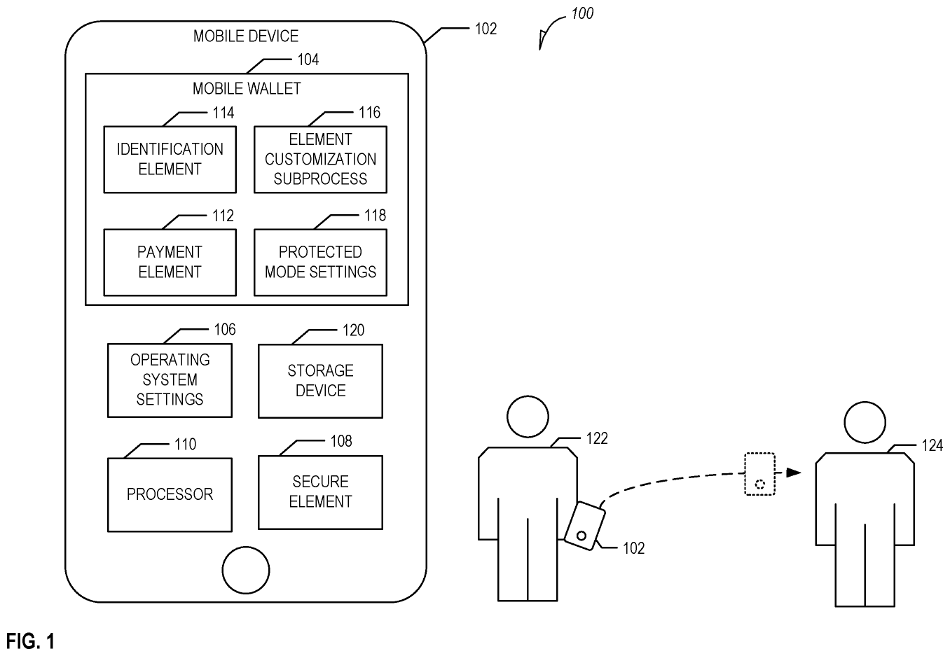

FIG. 1 illustrates a schematic representation of mobile device 102. The mobile device 102 includes mobile wallet 104, operation system settings 106, secure element 108, processor 110, and storage device 120. The mobile wallet 104 is illustrated as including payment element 112, identification element 114, element customization subprocess 116, and protected mode settings 118.

When a mobile wallet owner (represented as user 122) uses the mobile wallet, the owner may open the mobile wallet (e.g., select an icon on mobile device 102 representing mobile wallet 104) and select an element to use. In some cases, user 122 may have to hand over mobile device 102 with the mobile wallet open to others (represented as recipient 124) to process transactions or otherwise use information of a selected element. For instance, user 122 may submit their driver's license to a police or an insurance card to a receptionist at a doctor's office.

There is a potential security issue when recipient 124 gives the mobile wallet to recipient 124. Recipient 124, during possession of mobile device 102, may access or delete confidential information in the mobile device 102—intentionally or unintentionally. User 122 may want to confine access to information of the element that is needed by recipient 124 (or some other subset of data available on mobile device 102) when giving mobile device 102 to recipient 124. As discussed in more detail below, user 122 may use element customization subprocess 116 to create protected mode settings 118 to prevent recipient 124 from accessing information that user 122 wishes to remain private.

As mentioned previously, mobile wallet 104 may have a variety of payment and non-payment elements. For discussion purposes, mobile wallet 104 is illustrated with identification element 114 representing a non-payment element. However, the use of the labels of payment and non-payment elements does not restrict payment elements from being used for non-payment purposes (e.g., showing an expiration date of a credit card) or non-payment elements from being used in some manner for payment (e.g., verifying the identity of a purchaser at point-of-sale).

Elements that are part of mobile wallet 104 may be stored in a data store such as a database in storage device 120 and/or secure element 108. For discussion purposes, the elements are discussed in terms of separate data files, but other storage structures (e.g., entries in the database) may be used without departing from the scope of this disclosure.

A data file for an element may be in a structured format such as EXtensible Markup Language (XML). The XML file for an element may include property elements representing information that may be shown on a display device of mobile device 102. For example, a portion of an XML file may be:
<name>John Smith</name>
<credit card number>1234 5678 1111 1111</credit card number>
   The XML file may also identify locations of the information with respect to a graphical user interface. For example, a property element may include an x-coordinate and a y-coordinate, or relative coordinates from edges of the display device. The XML file may also include a unique identifier for the mobile wallet element.

Furthermore, an element may have protected and non-protected data. The use of these terms is to help distinguish between two types of data and other terms may be used without departing from the scope of this disclosure (e.g., private/public, confidential/non-confidential etc.). As discussed in more detail below, user 122 may classify the information as protected or non-protected using element customization subprocess 116. The XML file may include an attribute indicating the user's classification. Consider identification element 114, there may be a picture of the user and a student ID number as well as an address of the user. The address may not be necessary for identification purposes and be marked protected. A portion of the XML may then look like:
<address classification=“protected”>
   123 Apple St.
   New York, N.Y. 11111
</address>

Elements may be installed into mobile wallet 104 in a variety of manners. For example, user 122 may take a picture of a credit card using an image sensor of mobile device 102 (not shown). The mobile wallet 104 may process the picture using optical character recognition to determine information on the face of the credit card (e.g., number, name, expiration date). The mobile wallet 104 may contact—via a network device of mobile device 102—the provider of the credit card to verify that the card number is valid and matches the shown name. If valid, the credit card provider may transmit a token back to mobile device 102 that may be used when making a payment. The token may be stored in secure element 108 and transmitted (e.g., using near-field-communication, Bluetooth, etc.) to a point-of-sale terminal during payment.

The information determined from the face of the card and/or received from the provider may be stored in an XML data file for the element. In some instances, user 122 may select the type of the card being added and a template XML file may be retrieved. Each template may include property entries for the type of the element. For example, a credit card template may include a property entry for a credit card number and a student ID template may include a property entry for a student ID number. The aforementioned information may be put into the appropriate fields for the XML file (e.g., using if the OCR retrieves a 16-digit number it may be assumed it is the credit card number). The template may also have default classifications for the property types.

In addition to automatically adding information based on a picture or information retrieved from a card provider, user 122 may manually add mobile wallet elements. A user interface (UI) may be presented on the mobile device 102 with an option to add a mobile wallet element. The UI may also include a drop-down for a type of the element. Upon selection of a type, the mobile wallet 104 may retrieve a template for the element based on the type. The UI may then present the property fields for the template and user 122 may fill in the information. The mobile wallet 104 may then store an XML file for the element based on the entries made by the user. The user may also indicate what information is protected/non-protected.

In an example, user 122 may open mobile wallet 104 and be presented with a UI listing the installed mobile wallet elements. The UI may also present an option (e.g., a button next to an identification of the mobile wallet element) to customize the element for when the element is shown in a protected mode. Upon selection of the option, element customization subprocess 116 may be executed on processor 110. The element customization subprocess 116 may present a UI that shows a graphical representation of a portion of the information in the XML file for the selected mobile wallet element.

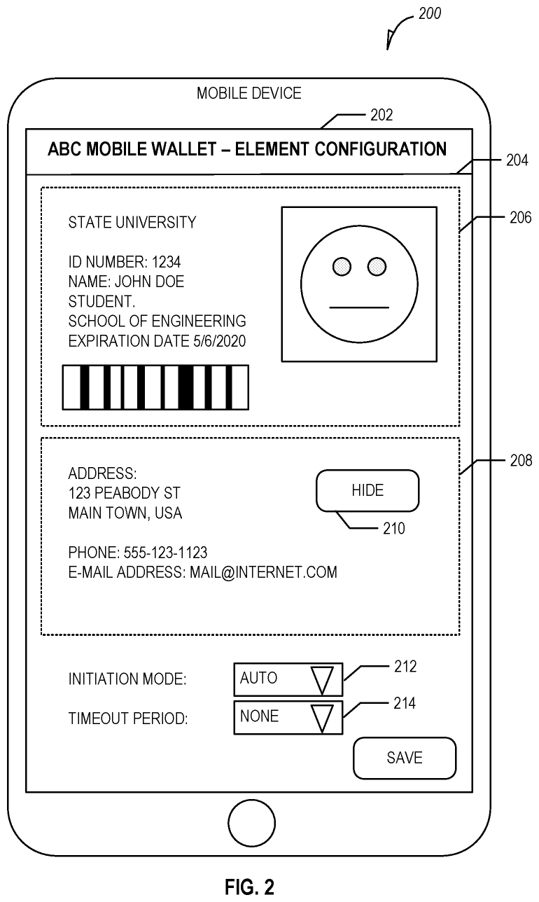

FIG. 2 illustrates a protected mode customization user interface 202, according to various examples. The UI includes student identification card 204 with non-protected data 206 and protected data 208, hiding element 210, initiation mode preference 212, and timeout preference 214. The customization user interface 202 may be shown in response to activation of customization subprocess 116. In an example, the customization user interface 202 is shown in response to a user installing a mobile wallet element.

As illustrated, non-protected data 206 includes the school's name, a photo, the student's name, an identity of the cardholder, an identification number, a barcode, an expiration date, and a school department. The protected data 208 includes a home address, telephone number, and an email address. The specific types of data that classified as protected or non-protected in FIG. 2 are for illustration purposes, and other classifications of information may be used.

The initial classification of a type of information may be set by the provider of the mobile wallet element. For example, the school issuing the student identification card 204 may have indicated that address and e-mail information is protected data. This indication may be provided using a standardized set of types information agreed upon between the mobile wallet provider and providers of the mobile wallet elements.

Thus, an electronic message (e.g., using an API call) from the issuer may be transmitted to the provider that identifies what types of information are protected or non-protected by default. This identification may be accessed (e.g., by having a local copy of the classifications or requesting the information from the mobile wallet provider) by the mobile wallet upon installation of the mobile wallet element. The corresponding XML file for the mobile wallet element may be updated in accordance with this information to provider the initial protected/non-protected classification. The initial classifications may also be set manually as discussed previously.

Customization user interface 202 includes visual markers to identify the data that is classified as non-protected or protected. The visual markers are dotted lines outlining the two sets of information, but other types of markers may be used such as shading, sizes, font, etc. The customization user interface 202 also includes hiding element 210 within protected data 208 thereby indicating to the user that the information in this portion is protected.

The XML file for a mobile wallet element may include protected mode settings. The protected mode settings may also be stored in a separate file that includes the settings for all mobile wallet element or as database entries—the settings may be tied to their respective mobile wallet element using the unique identifier discussed above. The protected mode settings for a mobile wallet element may include, but are not limited to, hiding settings for protected data, initiation mode setting, and time out setting. These three settings are represented in FIG. 2 as hiding element 210, initiation mode preference 212, and timeout preference 214.

The hiding element 210 may allow the user to determine whether or not the protected data is hidden when using the mobile wallet element in a protected mode. Activating the hiding element 210 may change the text of the hiding element 210 to “Show,” which may indicate to the user that the information is now set to hide. Other types of elements may be used to toggle between hiding and showing information. For example, a check may be shown that says “Check to hide protected information in a protected mode.” Regardless of the type of element, protected mode settings for the mobile wallet element may be updated based on the user activating/selecting/etc., the element (e.g., updating the XML file or a database entry). When the hiding element 210 is hidden, the user may have to enter a PIN or password to show it by touching the “Show” button.

The initiation mode preference 212 may allow the user to select how the protected mode is initiated for a mobile wallet element. In an example, the initiation mode is either auto or manual. The auto mode may be used to activate the protected mode automatically when the user selects a mobile wallet element to present (e.g., selects the mobile wallet element from a list of installed elements). In contrast, the manual mode allows the user to determine whether or not to present the mobile wallet element in a protected mode upon selection of the element. In other words, the mobile wallet may present an option upon selection of the element of whether or not to use the protected mode. Different mobile wallet elements may have different protected mode initiation settings. In other embodiment, the initiation mode and the timeout period may be universal to all elements and they can be specified in a separate configuration menu.

The timeout preference 214 may be used to determine when, if at all, the protected mode is disabled. Selecting “No,” as an example, using timeout preference 214 keeps the mobile wallet in the protected mode until the user disables the protected mode. Disabling the protected mode before the timeout expires may include the user entering a passcode or providing biometric authentication. In some examples, the user disables the protected mode in the same manners for unlocking the mobile device.

When in the protected mode, the screen timeout settings for the mobile device may be disabled. Thus, if the “No” timeout preference is used, the battery may continuously drain until the mode is disabled. This may become problematic if a user forgets to disable the protected mode before putting their phone away. Accordingly, a user may set the timeout preference to a certain amount of time (a timer) using the drop-down of timeout preference 214 (or other user interface element) after which the protected mode is automatically disabled.

As example, a mobile wallet user may configure his driver's license to be an auto-protected element. Thus, when the user selects the driver's license and gives it to a policeman due to a traffic violation, the policeman may take it to his police car for a background check. During this time, the policeman cannot access any other part of the mobile device (without authentication or a passcode) since the mobile wallet is used in the protected mode. Since the timeout mode is set, the mobile device may not switch to a blank screen based on an energy save mode in the mobile device configuration and the police can continuously read the display until the timeout expires. This may be useful even if there is not information of the mobile wallet that has been designated as protected as it prevents access to other information on the mobile device. In various examples, when a mobile wallet element is used in protected mode, it performs its normal function as an element. For example, even if a mobile wallet payment element is being used in a protected mode, it may be still being used for payment.

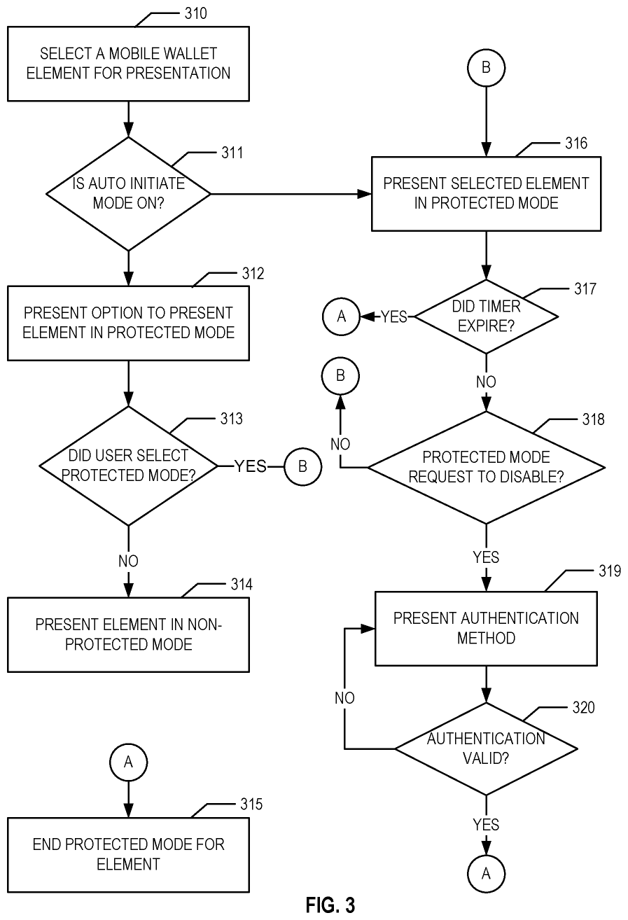

FIG. 3 illustrates a flowchart of a method of presenting a mobile wallet element. At operation 310, a user may select a mobile wallet element for presentation. To select an element, the user may first open the mobile wallet application on their mobile device. A list of installed mobile elements may be shown on the display device of the mobile device. The user may click on one of the mobile elements for presentation.

After selection of the mobile wallet element, the mobile wallet application may determine, at decision block 311, whether the initiation mode is set to auto or manual. The determination may be made by retrieving the XML file for the mobile wallet element or querying a database, according to various examples. If auto initiation is on, then at operation 316 the mobile wallet element is presented in a protected mode. Information that has been identified as protected, and indicated to not be shown in the protected mode, is not presented on the display device.

If the initiation mode is set to manual, then an option to present the mobile wallet in a protected mode is presented to the user at operation 312. If the user indicates to use the protected mode at decision block 313, flow continues at operation 316. If the user indicates to not use the protected mode, then the mobile wallet element is presented in a non-protected mode at operation 314. In a non-protected mode, all information for the mobile wallet may be shown and access to the rest of the mobile device may not be restricted.

While the mobile element is being presented in the protected mode, the mobile wallet checks if the protected mode timer (if any) has expired at decision block 317. If the timer is expired, the mobile wallet disables the protected mode at operation 315.

If the timer is not expired, the mobile wallet checks if a user has requested the protected mode be disabled at decision block 318. If a user did make such a request (e.g., swiping right, clicking a home button, etc.), an authentication message/window may be presented to the user at operation 310 to enter in authentication information such as a passcode or biometric information. If the authentication is valid (decision block 320), the mobile wallet protected mode may be disabled at operation 315. If the authentication is not valid, flow may continue back to operation 319. In an example, a failed authentication attempt returns flow to decision block 317.

In an example, when a mobile wallet element is in the protected mode, the mobile device may disable the screen timeout/sleep mode so that the mobile device does not go to black while the mobile wallet is being processed by others.

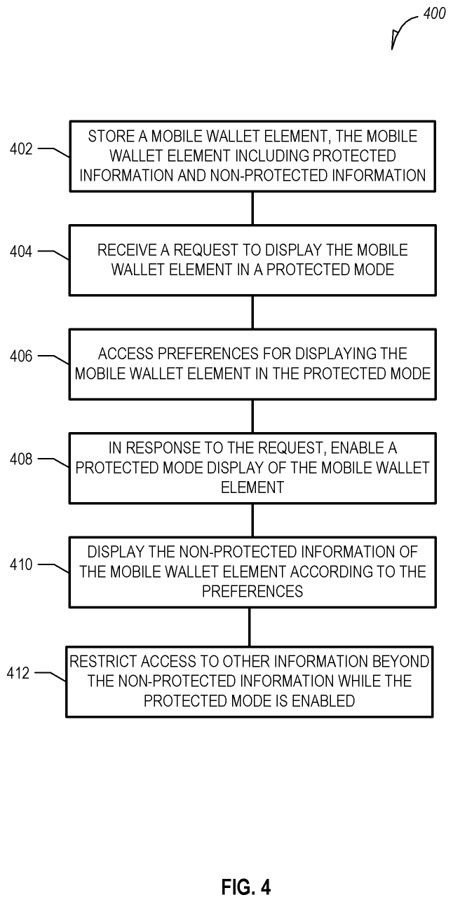

FIG. 4 is a flowchart of a method of using a protected mode for a mobile wallet element. Operations 402-412 may be embodied as instructions stored on a storage device of a computing device (e.g., a mobile device). The instructions may be executed by at least one processor of the computing device. When the instructions are executed, the at least one processor may be configured to perform operations 402-412. Performance may include controlling or communicating with other hardware elements of the computing device. For example, the at least one processor may transmit data to display on a display device of the mobile device.

At operation 402, a mobile wallet element may be stored in a storage device of a mobile device. The mobile wallet element may be comprised of a set of data elements (e.g., pictures, text, barcodes, etc.) Each data element may be designated as protected or non-protected. Thus, the mobile wallet element may include protected information and non-protected information. The mobile wallet element may be used for payment at a POS device or as identification, among other uses.

In various examples, a configuration mode may be presented that displays the set of data elements of a mobile wallet element with options to identify the data elements as protected or non-protected. For example, a user may select (e.g., click, tap) a data element. A pop-up menu may be presented that includes radio buttons (or other UI selection elements) to designate the selected item as protected or non-protected. A confirmation button may be displayed in the configuration mode after a user has made any designations. Upon activation of the confirmation button the designations may be stored as preferences (e.g., an entry in a database or XML file) for when the mobile wallet is displayed in a protected mode.

At operation 404, in an example, a request may be received on the mobile device to display the mobile wallet element in a protected mode. The request may be initiated by a user selected the mobile wallet element from a list of mobile wallets stored on the mobile device. In some examples, the mobile wallet elements are stored remotely from the mobile device.

At operation 406, preferences for displaying the mobile wallet element in a protected mode may be accessed. The preferences may include the designations of protected and non-protected data discussed above. The preferences may further include a timeout preference that indicates how long the protected mode should be enabled. The preferences may also indicate a type of the protected mode. For example, one type may be indicate that the mobile wallet element should automatically be enabled upon selection of the mobile wallet element. Types may be also be used to generate more granular sets of protected and non-protected data. For example, a data element may be designated as protected in a payment type mode, whereas it may be non-protected in a family type mode.

At operation 408, in response to the request to display the mobile wallet element in a protected mode, the protected mode for the mobile wallet is enabled. Enabling may include beginning a timer if the timeout preference has been set. Enabling may also include disabling a timeout of the display of the mobile device. At operation 410, the non-protected data elements may be displayed according to the preferences (e.g., those elements designated as non-protected).

Access to other information beyond the non-protected data elements may be restricted while the protected mode is enabled. (operation 412). For example, the protected information of the mobile wallet element may not be displayed and may not be accessed by activating UI or hardware elements of the mobile device before the timeout period or an authentication code is received.

Variations of the above examples may also be used without departing from the scope of this disclosure. Thus, a user may define a mobile wallet element with no protected information may the user may still wish to restrict access to the rest of the mobile device while in a protect mode. In some examples a user may allow access to a subset of the mobile wallet elements while in the protect mode. Thus, a user may indicate that a driver's licenses and credit card element may both be accessible while in the protect mode (each may just show their own non-protected information). A user may traverse between the two elements by swiping, in an example.

The protected mode may be disabled in a variety of ways. For example, the timeout period may be reached. In another example, a request (e.g., the user tapping the display screen, activating a button, etc.) to display the protected mode may be received. A user may be authenticated in response to the request. Authenticating may be include receiving a passcode (e.g., numbers, letters, combinations thereof) and comparing the passcode to a previously stored passcode. Authenticating may including receiving data from a biometric sensor of the mobile device. If the user is successfully authenticated, the protected mode may be disabled and access to non-protected data may be lifted. Similarly, access to other parts of the mobile device (e.g., other applications) may be permitted as well.

The above disclosure may also be used in other contexts. For example, a protect mode may be used with other, non-mobile wallet applications. Consider that a user gives his mobile phone to a stranger to a make a phone call. The user may want to lock-down the rest of the phone or component of the phone application-such as the contact list-to prevent the stranger from accessing extra information about the user. Similarly, a user may lend his/her phone to the stranger to use the map application on the mobile phone. The map application may be set to a protective mode to restrict access outside of the map application.

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

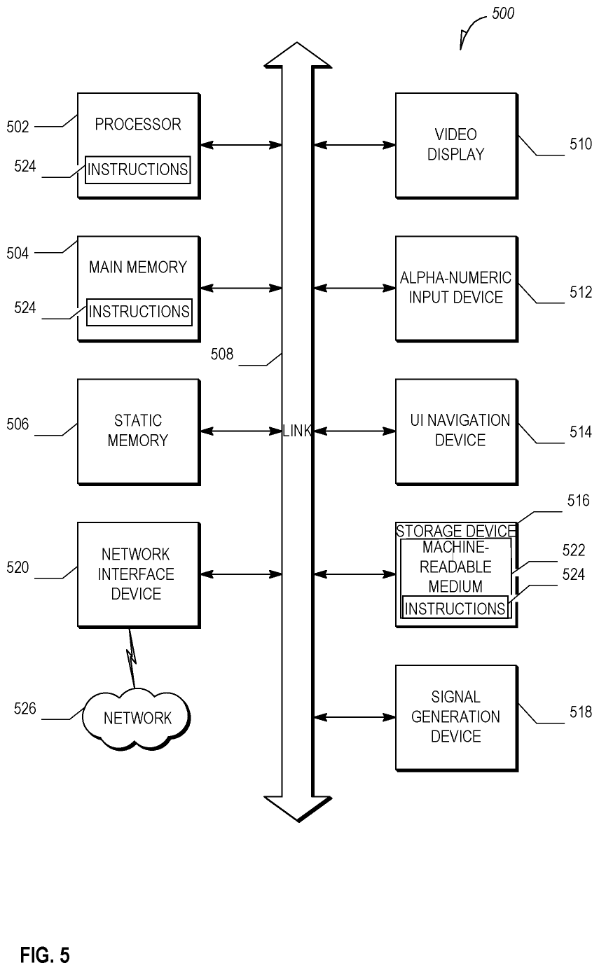

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 5G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
storing, in a storage device of a mobile device, a plurality of mobile wallet elements, each respective mobile wallet element of the mobile wallet elements including respective protected information and respective non-protected information, and the mobile wallet elements associated with a mobile wallet stored on the storage device, each respective mobile wallet element having a respective, separate structured data file stored on the storage device, each respective, separate structure data file including:
a plurality of property element entries, each property element entry identifying an individual piece of information for the respective mobile wallet element;
a classification attribute that identifies the individual piece of information as either protected or non-protected; and
location information with respect to a graphical user interface for the individual piece of information;
receiving a request, from a user, to open the mobile wallet;
in response to the receiving, displaying a list of the plurality of mobile wallet elements;
receiving a selection from the user, on the mobile device, from the list of displayed mobile wallet elements of a displayed mobile wallet element of the plurality of mobile wallet elements;
after receiving the selection, presenting an option to display the selected mobile wallet element in a protected mode or in an unprotected mode;
receiving an indication from the user of selection of the protected mode option, on the mobile device, to display the selected mobile wallet element in a protected mode; and
in response to the indication from the user:
accessing preferences for displaying the selected mobile wallet element in the protected mode from the selected mobile wallet element's structured data file;
enabling a protected mode display of the selected mobile wallet element;
displaying, on a display device of the mobile device, the non-protected information of the selected mobile wallet element according to the preferences; and
restricting access to the protected information of the selected mobile wallet element while the protected mode is enabled, the protected information determined by the classification attributes of the individual pieces of information in the mobile wallet element's structured data file.

2. The method of claim 1, wherein enabling the protected mode display of the mobile wallet element comprises:
disabling a timeout of the display device of the mobile device.

3. The method of claim 1, further comprising:
displaying configuration options, on the display device, for the mobile wallet element for when the mobile wallet element is to be displayed in the protected mode, the configuration options indicating a timeout preference for the protected mode;
receiving a time period for the timeout preference; and
storing the time period as part of the preferences.

4. The method of claim 3, further comprising:
disabling the protected mode when the time period has been reached.

5. The method of claim 1, wherein the mobile wallet element is comprised of a set of data elements and wherein the method further comprises:
displaying the set of data elements in a configuration mode;
receiving identification of at least one data element of the set of data elements as protected information; and
storing the identification as part of the preferences.

6. The method of claim 1, further comprising:
receiving a request to disable the protected mode;
authenticating a user in response to the request to disable the protected mode; and
disabling the protected mode when the user is successful authenticated.

7. The method of claim 6, wherein authenticating the user in response to the request to disable the protected mode comprises:
receiving a passcode entry on the mobile device; and
comparing the received passcode to a previously stored passcode.

8. The method of claim 6, wherein authenticating the user in response to the request to disable the protected mode comprises:
receiving biometric information of a user using a biometric sensor on the mobile device.

9. The method of claim 1, where enabling the protected mode display of the mobile wallet element comprises:
receiving a type of the protected mode in the preferences; and
displaying the mobile wallet element in the protected mode according to the type of the protected mode.

10. A non-transitory computer-readable medium comprising instructions, which when executed by at least one processor, configure the at least one processor to:
store, in a storage device of a mobile device, a plurality of mobile wallet elements, each respective mobile wallet element of the mobile wallet elements including respective protected information and respective non-protected information, and the mobile wallet elements associated with a mobile wallet stored on the storage device, each respective mobile wallet element having a respective, separate structured data file stored on the storage device, each respective, separate structure data file including:
a plurality of property element entries, each property element entry identifying an individual piece of information for the respective mobile wallet element;
a classification attribute that identifies the individual piece of information as either protected or non-protected; and
location information with respect to a graphical user interface for the individual piece of information;
receive a request, from a user, to open the mobile wallet;
in response to the request, display a list of the plurality of mobile wallet elements;
receive a selection from the user, on the mobile device, from the list of displayed mobile wallet elements of a displayed mobile wallet element of the plurality of mobile wallet elements;
after receiving the selection, present an option to display the selected mobile wallet element in a protected mode or in an unprotected mode;
receive an indication from the user of selection of the protected mode option, on the mobile device, to display the selected mobile wallet element in a protected mode; and
in response to the request from the user:
access preferences for displaying the selected mobile wallet element in the protected mode from the selected mobile wallet element's structured data file;
enable a protected mode display of the selected mobile wallet element;
display, on a display device of the mobile device, the non-protected information of the selected mobile wallet element according to the preferences; and
restrict access to the protected information of the selected mobile wallet element while the protected mode is enabled, the protected information determined by the classification attributes of the individual pieces of information in the mobile wallet element's structured data file.

11. The non-transitory computer-readable medium of claim 10, wherein to enable the protected mode display of the mobile wallet element, the at least one processor is configured to:
disable a timeout of the display device of the mobile device.

12. The non-transitory computer-readable medium of claim 10, wherein the at least one processor is further configured to:
display configuration options, on the display device, for the mobile wallet element for when the mobile wallet element is to be displayed in the protected mode, the configuration options indicating a timeout preference for the protected mode;
receive a time period for the timeout preference; and
store the time period as part of the preferences.

13. The non-transitory computer-readable medium of claim 12, wherein the at least one processor is further configured to:
disable the protected mode when the time period has been reached.

14. The non-transitory computer-readable medium of claim 10, wherein the mobile wallet element is comprised of a set of data elements and wherein the at least one processor is further configured to:
display the set of data elements in a configuration mode;
receive identification of at least one data element of the set of data elements as protected information; and
store the identification as part of the preferences.

15. The non-transitory computer-readable medium of claim 10, wherein the at least one processor is further configured to:
receive a request to disable the protected mode;
authenticating a user in response to the request to disable the protected mode; and
disabling the protected mode when the user is successful authenticated.

16. The non-transitory computer-readable medium of claim 15, wherein to authenticate the user in response to the request to disable the protected mode, the at least one processor is configured to:
receiving a passcode entry on the mobile device; and
comparing the received passcode to a previously stored passcode.

17. The non-transitory computer-readable medium of claim 15, wherein to authenticate the user in response to the request to disable the protected mode, the at least one processor is configured to:
receive biometric information of a user using a biometric sensor on the mobile device.

18. The non-transitory computer-readable medium of claim 10, where to enable the protected mode display of the mobile wallet element, the at least one processor is configured to:
receive a type of the protected mode in the preferences; and
display the mobile wallet element in the protected mode according to the type of the protected mode.

19. A system comprising:
at least one processor;
a display device;
a storage device comprising instructions, which when executed by the at least one processor, configure the at least one processor to:
store, in the storage device, plurality of mobile wallet elements, each respective mobile wallet element of the mobile wallet elements including respective protected information and respective non-protected information and the mobile wallet elements associated with a mobile wallet stored on the storage device, each respective mobile wallet element having a respective, separate structured data file stored on the storage device, each respective, separate structure data file including:
a plurality of property element entries, each property element entry identifying an individual piece of information for the respective mobile wallet element:
a classification attribute that identifies the individual piece of information as either protected or non-protected; and
location information with respect to a graphical user interface for the individual piece of information;
receive a request, from a user, to open the mobile wallet;
in response to the request, display a list of the plurality of mobile wallet elements;
receive a selection from the user, on the mobile device, from the list of displayed mobile wallet elements of a displayed mobile wallet element of the plurality of mobile wallet elements;
after receiving the selection, present an option to display the selected mobile wallet element in a protected mode or in an unprotected mode;
receive an indication from the user of selection of the protected mode option, on the mobile device, to display the selected mobile wallet element in a protected mode; and
in response to the request from the user:
access preferences for displaying the selected mobile wallet element in the protected mode from the selected mobile wallet element's structured data file;
enable a protected mode display of the selected mobile wallet element;
display, on the display device, the non-protected information of the selected mobile wallet element according to the preferences; and
restrict access to the protected information of the selected mobile wallet element while the protected mode is enabled, the protected information determined by the classification attributes of the individual pieces of information in the mobile wallet element's structured data file.
